(19) United States
(12) Patent Application Publication
(10) Pub. No.: US 2009/0272478 A1
(43) Pub. Date: Nov. 5, 2009

(54) Method of durably grafting a decorated fabric to a clothing

(76) Inventor: Inkyun Kim, Acradia, CA (US)

Correspondence Address: Inkyun Kim, 225 W. Carminireal Ave., Arcadia, CA, 91007, US

(21) Appl. No.: 12/383,867

(22) Filed: Mar. 31, 2009

(51) Int. Cl. B32B 37/06

(52) U.S. Cl. 156/60

(57) ABSTRACT

A method of durably grafting a decorated fabrics to a surface of any clothing is comprised of; 1) first step of pasting a burn out gel on each brim lines of the first patterns and gross outer line of the first pattern, which are developed on the first stencil, to allow the burn-out gel pasted on the fabric according to the first pattern and the gross outer-line of the first stencil, 2) second step of pasting grafting glue on each brim lines of the second patterns, which is developed on the second stencil, to allow the grafting glue pasted on the fabric according to the brim line of the second pattern of the second stencil, 3) third step of drying the burn out gel and the grafting glue pasted fabric on a dryer at 160° C. for 1 to 5 minutes and tear out the pattern printed fabric along the gross outer line, 4) fourth step of overlapping the fabric, which is treated as the second and the third step, on a clothing, which is engaged on a support plate, and apply heat pressing for 10 to 30 seconds at 160° C., and 5) fifth step of removing the left of burn out from the grafted fabric by washing with a weak alkali solution followed by water washing. This technology can be applied to any kind of fabrics.

### 1. FIELD OF THE INVENTION

Current application relates to a method of durably gluing fabrics each other, especially relates to a method of durably gluing a decorated fabric to another clothing.

### 2. BACKGROUND OF THE INVENTION

Recently, many kind of technologies are introduced to decorate clothes to meet requirements of young customers. Customers' requirement asking various different designs makes it very difficult to realize. Printing might be the easiest way for decorating jeans with various designs. But, repeated washing deteriorates the drawings. Embroidering is the most durable and popular method of decorating the jeans. But, production cost for various designs is high. Gluing may be one of the cheap and convenient methods of grafting jeans with designed fabrics if it is durable. Some of the gluing method on the market is pasting a glue on whole rear side of a decorated fabric and attach it directly on a clothes using a grafting glue that is similar to the glue that was used in the former invention, U.S. patent application Ser. No. 12/313,795, of the applicant of the current invention and press with heat. However, such method can not provide an endurable grafting method. That is because due to the difference of the flexibility of the grated glue and the flexibilities of fabric is totally different and repeated washing need stretching and shrinking of the grafted clothes. As a result, the grafted clothes made by conventional method are easily separated even after few washings. It is purpose of the current application to develop a method of durably gluing decorated fabrics to any clothes.

### DESCRIPTION OF PRIOR ART

U.S. Pat. No. 5,758,588 to Orfali illustrates an applique such as a lace-trimming is grafted onto a region of a textile product, such as a towel or a pair of blue-jeans.

U.S. Pat. No. 4,860,387 to Williams illustrates a decorated garment (11) has a plurality of doll figures (12,13,14) mounted on its front surface. Articles of clothing (26) for each of the doll figures are adapted to be attached to the doll figures to provide decorative wardrobes for the doll figures.

U.S. Pat. No. 5,087,664 to Sugino, et al. Illustrates a plastisol composition comprising a vinyl chloride polymer, a plasticizer and an adhesion-imparting agent, characterized in that the adhesion-imparting agent is a diisocyanate polymer blocked with an oxybenzoic acid ester or with an alkylphenol and having an average molecular weight within a range of from 1,000 to 10,000.

None of the prior art illustrates a method of grafting any fabric onto any clothing to produced a glued cotton wear durable over 1,000 times mechanical washing.

### SUMMARY IF THE INVENTION

Embroidering is the most durable and popular method of decorating the jeans. But, production cost for various designs is high. Gluing may be one of the cheap and convenient methods of grafting jeans with designed fabrics if it is durable. Some of the gluing method on the market is pasting a glue on whole rear side of a decorated fabric and attach it directly on a clothes using a grafting glue. Such method can not provide an endurable grafting method because due to the difference of the flexibility of the grated glue and the flexibilities of fabric is totally different and repeated washing need stretching and shrinking of the grafted clothes. The clothes made by conventional method are easily separated even after few washings. It is purpose of the current application to develop a method of durable product. The method is comprised of; 1) first step of pasting a burn out gel on each brim lines of the first patterns and gross outer line of the first pattern, which are developed on the first stencil, to allow the burn-out gel pasted on the fabric according to the first pattern and the gross outer-line of the first stencil, 2) second step of pasting grafting glue on each brim lines of the second patterns, which is developed on the second stencil, to allow the grafting glue pasted on the fabric according to the brim line of the second pattern of the second stencil, 3) third step of drying the burn out gel and the grafting glue pasted fabric on a dryer at 160° C. for 1 to 5 minutes and tear out the pattern printed fabric along the gross outer line, 4) fourth step of overlapping the fabric, which is treated as the second and the third step, on a clothing, which is engaged on a support plate, and apply heat pressing for 10 to 30 seconds at 160° C., and 5) fifth step of removing the left of burn out from the grafted fabric by washing with a weak alkali solution followed by water washing. This technology can be applied to any kind of fabrics.

### BRIEF DESCRIPTION OF DRAWINGS

FIG. 1 is a schematic drawing of the first step of pasting burn-out gel on a fabric utilizing first stencil.

FIG. 2 is the first pattern and gross outer-line developed on the first stencil for pasting burn-out gel on inside of a fabric.

FIG. 3 is a schematic drawing of the second step of pasting grafting glue on a burn out pasted fabric utilizing second stencil.

FIG. 4 is the second pattern developed on the second stencil for pasting grafting glue on the burn-out gel pasted fabric.

FIG. 5 is the third pattern developed on the surface of the fabric after step two.

FIG. 6 is a schematic drawing comparing the patterns developed on the first stencil and on the second stencil.

FIG. 7 is a schematic cross-sectional view of the fabric, which is pasted with burn out gel and grafting glue, along the line A-A′ in the FIG. 3.

FIG. 8 is a schematic drawing of attaching the patterned fabric on a clothing utilizing a heating press.

FIG. 9 is the final pattern developed on a cloth after washing.

### DETAILED DESCRIPTION OF THE PREFERRED EMBODIMENT

It is purpose of the current application to provide a simple method to manufacture a durably grafting decorated fabrics on any cloths.

Different from the prior art the procedure of manufacturing a durably grafting decorated cotton fabric to cotton cloths is as follows;

The first step is to overlap the first stencil (3) on a fabric (2) and paste burn-out gel (1), which is a mixture of natural alginate, strong acid of printgen® OP-30PS, glycerine, and water, along each brim lines (3-3) of the first pattern (3-1) and the gross outer-line (3-2) of the first stencil (3) to allow the burn-out gel (1) pass through the brim lines (3-3) of the first pattern (3-1) and pass through a gross outer line (3-2). The burn-out gel (1) develop another pattern (2-1), which exactly matches to the first pattern (3-1) and the gross outer-line (3-2) on the first stencil, on the inner side of the fabric (2).

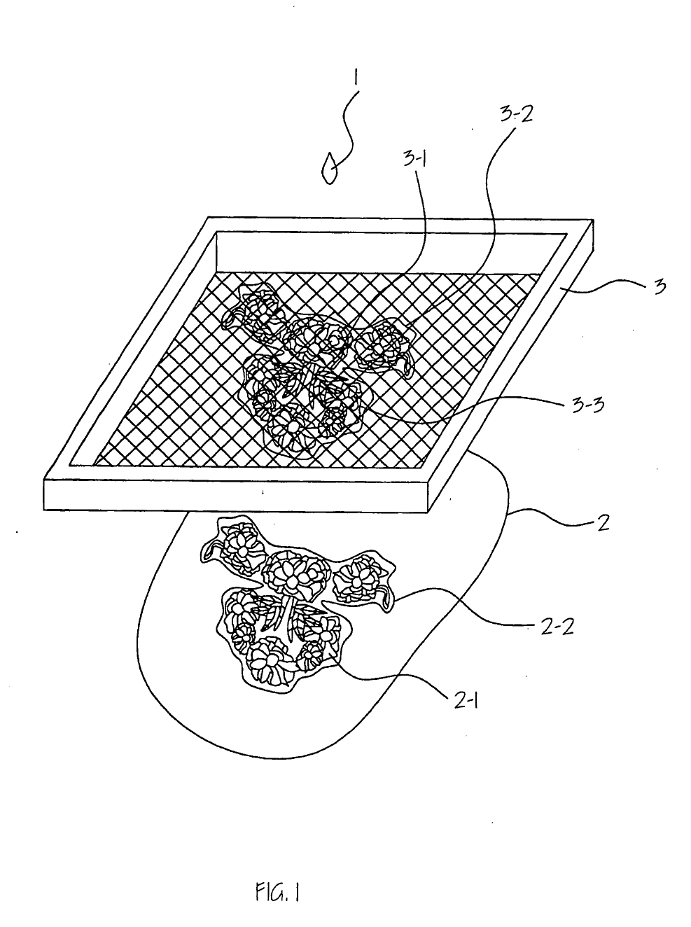

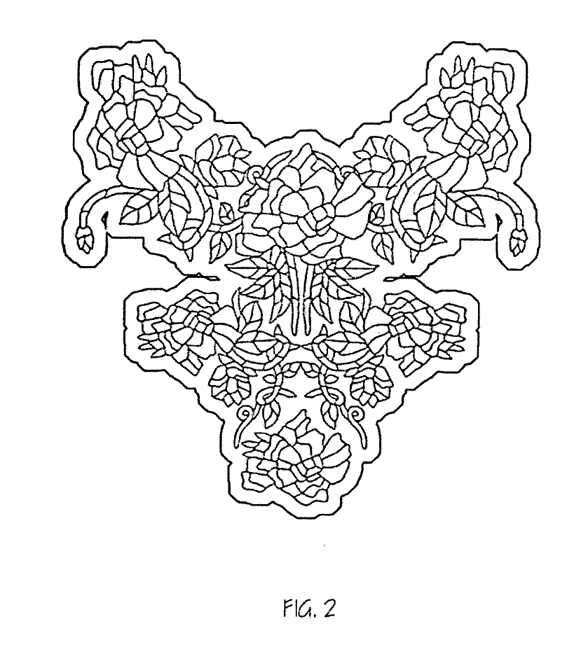

FIG. 1 is a schematic drawing of the first step of pasting burn out gel (1) on a fabric (2) utilizing the first stencil (3). The first pattern (3-1) is developed on the first stencil (3) by conventional method. FIG. 2 is the first pattern (3-1) developed on the first stencil (3) for pasting the burn-out gel (1) on inside of a fabric (2). In addition to the pattern (3-1), a gross outer-line (3-2) is developed around the pattern (3-1). As the first stencil (3) is over-lapped on the fabric (2) and the burn out gel (1) is applied, the burn out gel (1) is pasted on the fabric (2) forming another pattern (2-1) and pasted gross outer-line (2-2). At this moment, the burn out gel is pasted on the inner side of a fabric (2), where the fabric (2) faces a clothes to be attached.

The second step is to overlap a second stencil (3′) on the burn-out gel (1) pasted fabric (2′) and paste a grafting glue (4) (Polyone S11111 series-one clear, which contains 1 to 5% of fume silica for inhibitor, from Polyone Corporation) along the second pattern (3′-1) that is developed on the second stencil (3′) to allow the grafting glue (4) pass through the brim lines (3′-2) of the second pattern (3′-1). The grafting glue (4) is pasted on the another pattern (2′-1), along the brim lines (3′-2) of the second pattern (3′-1), on the inner side of the burn-out gel pasted fabric (2′).

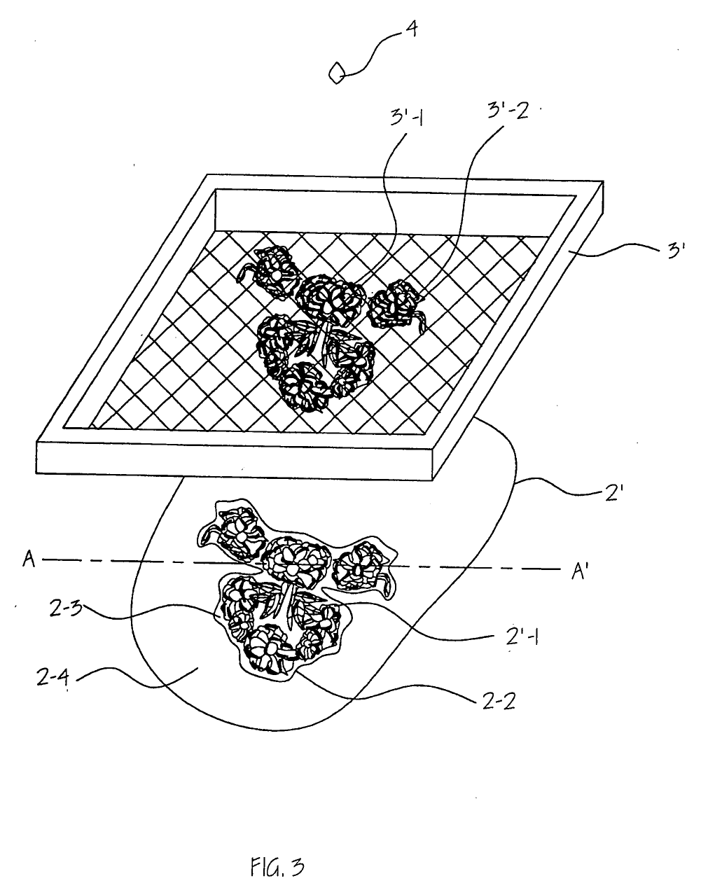

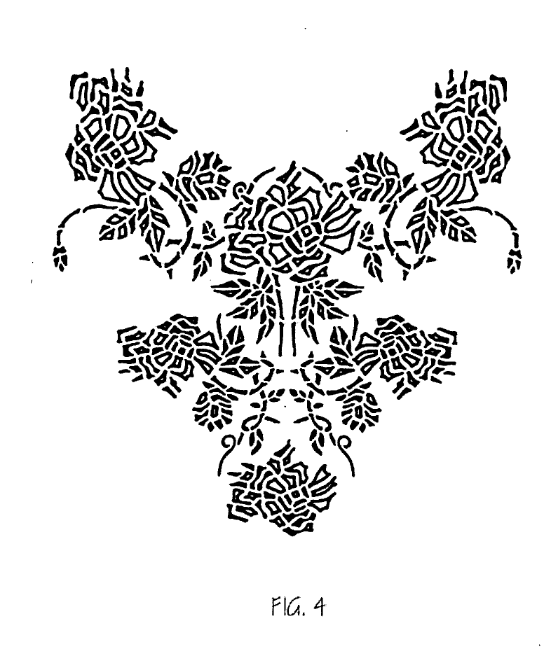

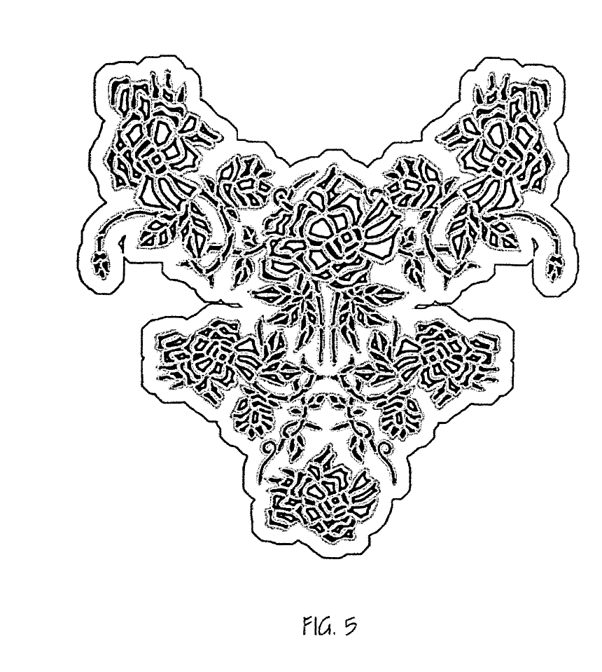

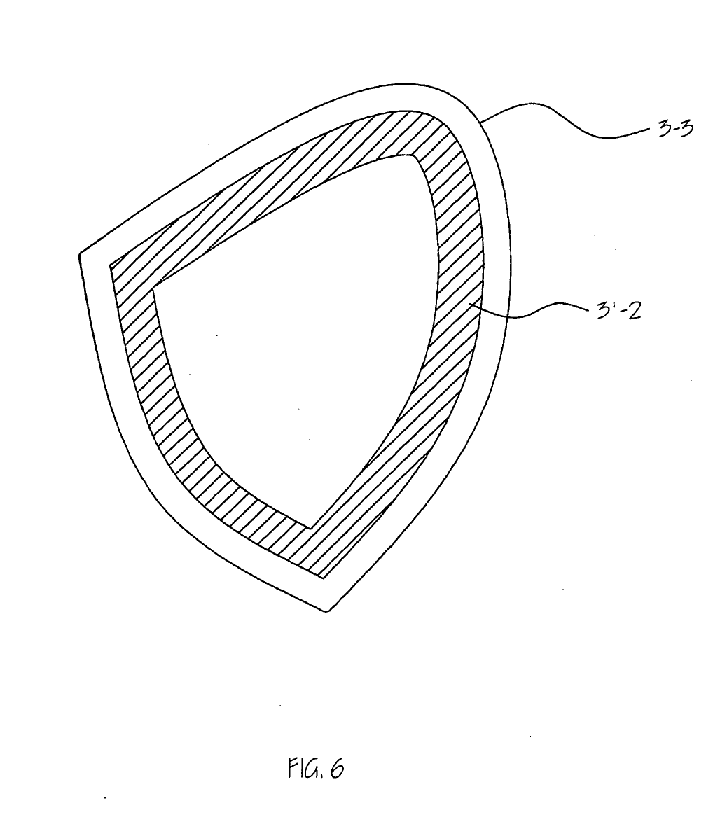

FIG. 3 is a schematic drawing of the second step of pasting grafting glue (4) on a burn out gel pasted fabric (2′) utilizing the second stencil (3′). FIG. 4 is the second pattern (3′-1) developed on the second stencil (3′) for pasting grafting glue (4) on the burn-out gel (1) pasted fabric (2′). The second stencil (3′) has the same pattern (3′-1) as that (3-1) on the first stencil (3). But, there is no gross outer-line (3-2). FIG. 5 is the third pattern developed on the surface of the fabric (2′) after step two. And FIG. 6 is a schematic drawing comparing brim lines of (3-3) and (3′-2) of the first and the second pattern developed on the first stencil (3) and on the second stencil (3′), respectively. The second pattern (3′-1) on the second stencil (3′) has brim lines (3′-2) which are broader than that (3-3) of the pattern (3-1) on the first stencil (3). The brim lines (3-3) of the first pattern (3-1) on the first stencil (3) surround the brim lines (3′-2) of the second pattern (3′-1) on the second stencil (3′).

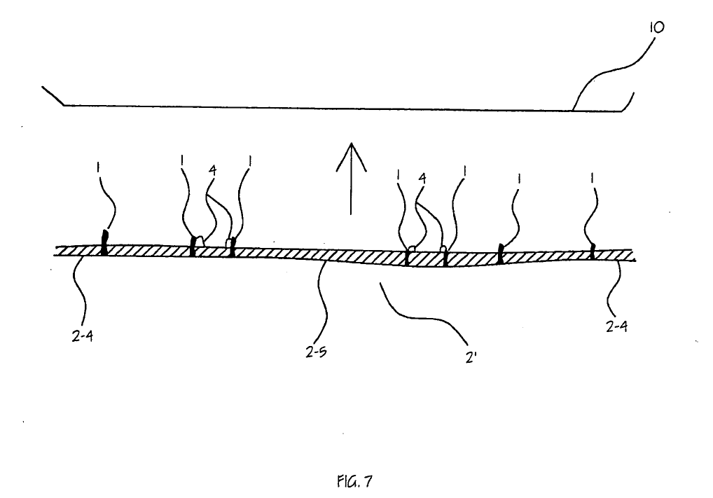

The third step is to treat the fabric (2′), which has been pasted with the burn out gel (1) and the grafting glue (4) to form the third pattern (2-1) thereon, with heat by passing them on a heated conveyer for 1 to 5 minutes and tear out the outer portion (2-4) of the fabric (2′) with hand. The conveyer is main-tained at 160° C. (320° F.). After that tear out the fabric (2′) along the gross outer line (2-2) of the pattern. FIG. 7 is a schematic cross-sectional view of the fabric (2′), which is pasted with the burn-out gel (1) and grafting glue (4), along the line A-A′ in the FIG. 3. At this step, the burn-out gel (1) on the fabric melt and smeared into the textile structure of the fabric (2′). The smeared burn-out gel partly melt out the textile structure. The burn-out gel (1), which does not contact the grafting glue (4), melt out the textile structure faster. While the grafting glue (4) still remain gelatin state on the surface. So, it is possible to separate the patterned portion (2-3) from the patch of the fabric (2′) by just tear out the outer portion (2-4) of the fabric (2′).

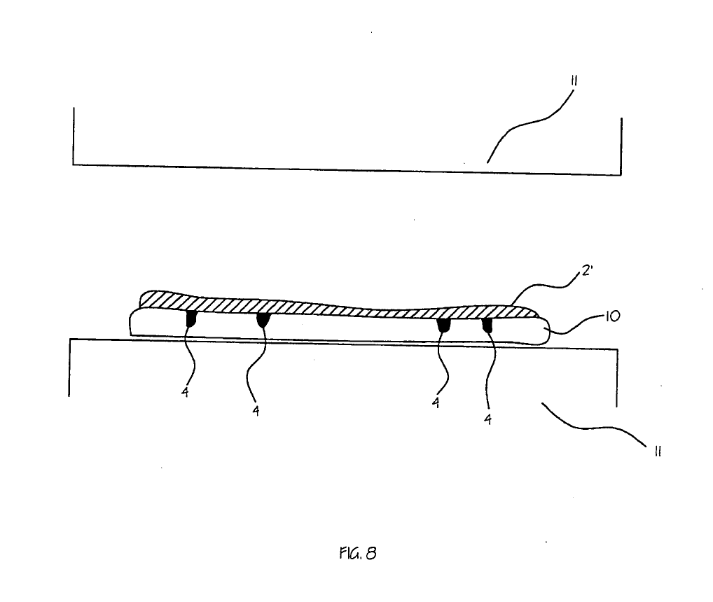

The fourth step is to upside down the patterned portion (2-3) of the fabric (2′) and overlap the patterned portion (2-3) on a desired place of a clothing (10) and engage them between a heating press (11) at 160° C. (320° F.) for 10 to 30 seconds. FIG. 8 is a schematic drawing of attaching the patterned fabric on a clothing utilizing a heating press.

In this step, the grafting glue (4) smeared into woven structure of the clothing (10) as shown in the FIG. 8. According to the Polyone's catalogue the Plastisols contains PVC (Polyvinylchloride) resins. Based on the material safety data sheet and catalogue of the Polyone corporation and Sugino, et al.'s U.S. Patent 664′, the plastisol composition of Polyone is a vinyl chloride polymer, a plasticizer and an adhesion-imparting agent, characterized in that the adhesion-imparting agent is a diisocyanate polymer blocked with an oxybenzoic acid ester or with an alkylphenol and having an average molecular weight within a range of from 1,000 to 10,000. So, when the glue is pasted on the fabrics, it is sol-type oligomer. But, when heat is applied it melts first and penetrates and smeared into the clothes as shown in the FIG. 8.

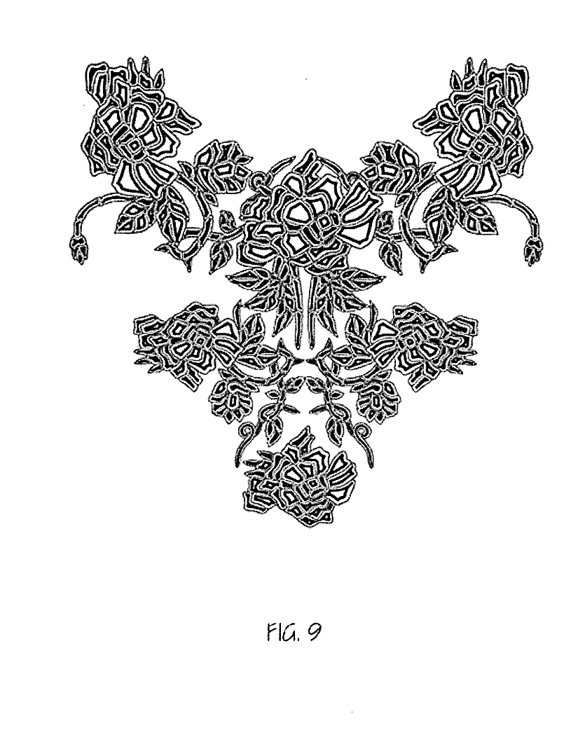

The fifth step is to wash fabric (2′) grafted clothing (10) with a weak alkali solution followed by a washing machine. Then the portion (2-5), surrounded with the burn-out gel (1), in FIG. 7 will be washed out and the fourth pattern like FIG. 9 will be developed on the clothing (10) with fabric (2′).

For the above step, the clothing and fabric may be polyester, nylon, and linen and any other artificial fabrics. In this step, marble washing may be applied to make the clothing look like used one. Durability of the grafted fabric (2′) on the clothing (10) is tested by laundering and drying repeatedly. Even after 100 times of machine laundering, the fabric (2′) solidly attached to the clothing (10).

What is claimed is:

1. A method of durably grafting decorated fabrics to a clothing with stencils is comprised of;
first step of overlapping the first stencil on a fabric and paste burn-out gel, which is a mixture of natural alginate, strong acid of printgen® P-30PS, glycerine, and water, along the first pattern of the first stencil to allow the burn-out gel pass through the brim lines of the first pattern and pass through a gross outer-line develop another pattern, which exactly matches to the first pattern and the gross outer-line on the first stencil, on the inner side of the fabric, where the fabric faces a clothes to be attached, and
second step is to overlapping a second stencil on the burn-out gel pasted fabric and paste a grafting glue (Polyone S11111 series-one clear, which contains 1 to 5% of fume silica for inhibitor, from Polyone Corporation) along the second pattern that is developed on the second stencil to allow the grafting glue pass through the brim lines of the second pattern and paste the grafting glue, along the brim lines of the second pattern, on the another pattern developed on the inner side of the fabric, and
third step of treating the fabric, which has been pasted with the burn out gel and the grafting glue to form third pattern thereon, with heat by passing them on a heated conveyer, that maintained at 160° C., for 5 minutes to allow the burn-out gel on the fabric melt and smeared into the textile structure of the fabric and partly melt out the textile structure and tear out the outer portion of the fabric with hand along the gross outer line of the pattern, and
fourth step of upside down the patterned portion of the fabric and overlapping the patterned portion on a clothing and engaging them between a heating press at 160° C. for 20 seconds to allow the grafting glue smeared into woven structure of the clothing, and
fifth step of washing the fabric grafted clothing with a weak alkali solution followed by a washing machine to remove the portion, surrounded with the burn-out gel.

2. A method of durably grafting decorated fabrics to a clothings with stencils in claim 1 wherein, the grafted clothes is durably attached to the clothing even after 100 times of machine laundry.

3. A method of durably grafting decorated fabrics to a clothing with stencils in claim 1, where in the fabrics is made of 100% cotton.

4. A method of durably grafting decorated fabrics to a clothing with stencil in claim 1, wherein the clothing is made of 100% cotton.

5. A method of durably grafting decorated fabrics to a clothes with stencils in claim 1, wherein the fabrics is made of polyester.

6. A method of durably grafting decorated fabrics to clothing with stencils in claim 1, wherein the clothing is made of polyester.

7. A method of durably grafting decorated fabrics to a clothing with stencil in claim 1, marble wash is applied at the fifth step of washing.

8. A method of durably grafting decorated fabrics to a clothing with stencil in claim 1, laser cut out is applied to burn out the brim lines and gross outer-lines.
